(19) United States
(12) Patent Application Publication
(10) Pub. No.: US 2022/0139690 A1
(43) Pub. Date: May 5, 2022

(54) System for Monitoring and Controlling the Composition of Charged Droplets for Optimum Ion Emission

(71) Applicant: DH Technologies Development Pte. Ltd., Singapore (SG)

(72) Inventors: Thomas R. Covey, Newmarket (CA); Chang Liu, Richmond Hill (CA); Stephen A Tate, Barrie (CA)

(21) Appl. No.: 17/427,428

(22) PCT Filed: Feb. 3, 2020
(86) PCT No.: PCT/IB2020/050851

§ 371 Date: Jul. 30, 2021

Related U.S. Application Data
(60) Provisional application No. 62/800,212, filed on Feb. 1, 2019.
(60) Provisional application No. 62/855,638, filed on May 31, 2019.

(51) Int. Cl. H01J 49/16; H01J 49/04; G01N 30/72

(52) U.S. Cl. CPC H01J 49/167; G01N 30/7253; H01J 49/0445

(57) ABSTRACT

A device that produces charged droplets whose composition is optimized for the creation of ions by electro spray composed of: a transport device that is operative to transfer sample components from a liquid sample to a processing chamber, a flowing stream of liquid through the processing chamber into which the samples are deposited, a controller mechanism operative to control the amount of sample transferred, a transport tube through which the flowing liquid containing the sample is directed to an electro spray emitter with a high electric field at the exit, a flow of expanding gas surrounding the electro spray emitter creating a pressure drop at the exit, and, a mass spectrometer for measuring the number of ions produced from the charged droplets emanating from the emitter; wherein the dilution of the sample in the processing chamber and transport fluid is from 100 to 10,000-fold.

### RELATED US APPLICATIONS

This application claims the benefit of priority from U.S. Provisional Application No. 62/800,212, filed on Feb. 1, 2019 and 62/855,638, filed on May 31, 2019, the contents of both of which are incorporated by reference herein.

### FIELD

The invention relates generally to sample analysis and methods and more particularly to those involving measurements with electrospray mass spectrometry.

### BACKGROUND

The production of ions from liquid solutions by the electrospray process has been a successful method of sample introduction for measurement by mass spectrometry. Both organic and inorganic molecules and atoms in liquid solutions from a broad range of chemical classes can be converted into unfragmented gas phase ions using this approach. Ion production is very efficient enabling low limits of detection for both molecular mass determination and quantitative measurements of the number of such molecules under the right conditions.

The analysis of biological and other samples by electrospray mass spectrometry can, however, be slowed down, complicated, and sometimes prohibited by the presence of high concentrations of solutes in the sample comprised of endogenous compounds and, in some instances the analyte itself. In these circumstances the high concentration of solutes leads to a condition referred to as “ion suppression” in which the electrospray process is not effective at fully converting the input liquid solution into unfragmented gas phase ions. Ion suppression is a key reason that direct analysis of biological samples without sample preparation to dilute and purify the biological samples is largely prohibited, along with the risk of contaminating the mass spectrometer.

There is a need for systems and methods which allow for the analysis of biological and other samples while reducing the initial sample preparation and purification requirements before introduction into an analytical device.

### SUMMARY

In an embodiment, systems and methods are provided for: i) detecting when conditions in ion emitting droplets are such that ion suppression is occurring; and, ii) correcting for ion suppression by adjusting concentrations of solutes in these droplets to reduce or eliminate ion suppression. In aspects, systems and methods are provided to adjust concentrations of solutes in ion emitting droplets to ensure an analytical response of a receiving analytical device is within the linear dynamic range region of the analytical device. In some aspects, the systems and methods are operative to perform the detection and correction in near real time fashion without operator intervention. In some aspects, the systems and methods are operative to perform detection and apply a correction to the system in less than 5 seconds, and more preferably in less than 1-2 seconds.

In an embodiment, systems and methods are provided for: i) detecting when conditions in ion emitting droplets are such that ion suppression is occurring; and, ii) correcting for ion suppression by evaluating a detected reference signal of a reference standard included in the ion emitting droplets based on an expected reference signal of the reference standard and adjusting a detected analyte signal of an analyte in the ion emitting droplets based on the evaluation.

In an embodiment, systems and methods are provided for detecting when conditions in ion emitting droplets are such that ion suppression is occurring by evaluating a detected reference signal of a reference standard included in the ion emitting droplets based on an expected reference signal of the reference standard and identifying ion suppression when the detected reference signal deviates from the expected reference signal. In some aspects, the systems and methods are further operative to correct for the detected ion suppression by adjusting a detected analyte signal of an analyte in the ion emitting droplets based on the deviation of the detected reference signal from the expected reference signal.

In an embodiment, a device that produces charged droplets is described whose composition is optimized for the creation of ions by electrospray. The device comprises a sample delivery device that is operative to transfer sample components from a liquid sample to a processing chamber defining a processing region of a sample processing component, a flowing stream of liquid through the processing chamber into which the samples are deposited, a controller operative to control the amount of sample transferred, a transport tube through which the flowing liquid containing the sample is directed to an electrospray emitter with a high electric field at the exit, a flow of expanding gas surrounding the electrospray emitter creating a pressure drop at the exit, and, a mass spectrometer for measuring the number of ions produced from the charged droplets emanating from the emitter; wherein the dilution of the sample in the processing chamber and transport fluid is from 100 to 10,000-fold.

In some embodiments, the device varies the sample droplet volume directed into the processing chamber.

In some embodiments, the device varies the frequency of sample droplet generation directed into the processing chamber.

In some embodiments, the device varies the amount of sample introduced into the processing chamber from a solid surface by controlling the time the solid surface spends in a liquid sample.

In some embodiments, the device varies the amount of sample introduced into the processing chamber from a solid surface by controlling the time the solid surface spends in the processing fluid.

In some embodiments, the device varies the amount of sample introduced into the processing chamber from a solid surface by controlling the composition of the processing fluid in contact with the solid surface in the processing chamber.

In some embodiments, the device varies the flow of the fluid in the processing chamber.

In some embodiments, the device varies the flow of the nebulizer gas.

In some embodiments, the device is further operative to determine a relationship between the amount of sample injected and signal produced in the mass spectrometer and compares it to a known normal relationship.

In some embodiments, the device is operative to adjust the amount of sample introduced into the processing chamber to another value if the relationship between sample amount and signal varies from the normal.

In some embodiments, the device is operative to adjust the sample droplet frequency to another value if the relationship between sample amount and signal varies from the normal.

In some embodiments, the device is operative to adjust the transport flow to another value if the relationship between sample amount and signal varies from the normal.

In some embodiments, the device is operative to adjust the nebulizer gas flow to another value if the relationship between sample amount and signal varies from the normal.

In some embodiments, the device is further operative to adjust the amount of time a solid sample is in contact with the fluid in the processing chamber to another value if the relationship between sample amount and signal varies from the normal.

In some embodiments, the device is further operative to adjust the composition of the solvent in the processing chamber in contact with a solid sample to another value if the relationship between sample amount and signal varies from the normal.

In some embodiments, a method for adjusting a composition of the charged droplets that create gas phase ions to compensate for samples whose composition is outside the boundaries of those required for optimal ion production is described which includes: creating sample droplets from a liquid sample, introducing said sample droplets into a flowing stream of liquid, diluting said sample droplets in said flowing stream of liquid from 100 to 10,000 fold, and introducing the flowing stream of liquid and said diluted sample droplets into an electrospray ionization mass spectrometer to obtain a signal representative of components of the sample.

In some embodiments, the method increases the amount of the sample introduced by increasing the sample droplet volume and determines the relationship between amount of sample introduced and the mass spectrometer signal.

In some embodiments, the method increases the amount of the sample introduced by increasing the frequency of sample droplet introduction determines the relationship between amount of sample introduced and the mass spectrometer signal.

In some embodiments, the method compares the relationship between the amount of sample introduced and the mass spectrometer signal to a calibration curve of sample amount versus signal predetermined under solution composition conditions for ideal ion production from charged droplets.

In some embodiments, the method decreases the amount of sample introduced by lowering the droplet volume until the relationship between the amount of sample introduced and the mass spectrometer signal is equivalent to that of an ideal calibration curve of sample amount versus signal.

In some embodiments, the method decreases the amount of sample introduced by lowering the frequency of sample droplet introduction until the relationship between the amount of sample introduced and the mass spectrometer signal is equivalent to that of an ideal calibration curve of sample amount versus signal.

In some embodiments, the method increases the transport fluid flow until the relationship between the amount of sample introduced and the mass spectrometer signal is equivalent to that of an ideal calibration curve of sample amount versus signal.

These and other embodiments are contemplated in accordance with the attached claims.

### BRIEF DESCRIPTION OF THE FIGURES

FIG. 1A is a system diagram illustrating an embodiment of a mass analysis system.

FIG. 1B a block diagram illustrating an embodiment of computing resources for enabling the mass analysis system.

FIG. 2 is an idealized plot illustrating the relationship between electrospray sample concentration versus mass analyzer response.

FIG. 3 is a simplified plot illustrating the relationship between electrospray sample concentration versus mass analyzer response.

FIG. 4 is an exemplary embodiment of a device in accordance with the present teachings.

FIGS. 5A, 5B and 5C depicts various geographical relationships of the components of a device in accordance with the present teachings.

FIG. 6 depict various embodiments of the sample processing region in accordance with the present teachings.

FIG. 7 depict various embodiments of methods of sample introduction.

FIG. 8 depicts a sequence of events leading up to creation of ions by electrospray.

FIG. 9 depicts droplet conditions in various regions.

FIG. 10 is a comparison plot of various verapamil analyses.

FIG. 11 is a plot of data illustrating the detection and correction of suppression effects in a fermentation broth media.

FIG. 12A is a plot of ion signal during sampling runs that illustrates the real time nature of this process.

FIG. 12B is a closer up view of some of the data in FIG. 12A.

FIG. 13 is a simplified schematic illustrating an embodiment of a system for detecting ion suppression.

FIG. 14 is a diagram illustrating an embodiment of a method for correcting for ion suppression in an analytical result.

### DETAILED DESCRIPTION

In some embodiments a system is provided for analyzing a sample. In some aspects, the system may be operative to produce charged sample droplets containing sample components for analysis and to optimize a composition of the produced charged sample droplets for the creation of sample ions by electrospray.

In some embodiments, a system is provided for analyzing a sample material. The system comprising a sample delivery component for delivering measured volumes of sample from the sample material to a processing chamber. A flowing stream of liquid flowing through the processing chamber receives and captures delivered measured volumes of sample. A transport conduit is provided to convey the flowing stream of liquid and captured sample to an electrospray emitter with a high electric field at a discharge end. The flowing stream of liquid comprising a solvent for diluting the captured sample. In some aspects, the systems and methods are operative to dilute the captured sample 100 to 10,000-fold. The electrospray emitter operative to discharge the flowing stream of liquid and diluted sample at the discharge end in the form of charged sample droplets. A flow of expanding gas is directed to surround the discharge end of the electrospray emitter creating a pressure drop at the discharge end and converting the charged sample droplets into sample ions. A mass analysis device operative to receive and analyze the sample ions and to produce analysis results representative of the delivered sample.

In some aspects, the system further comprises a sample delivery control component for controlling the measured volumes of sample delivered to the processing chamber.

In some aspects, the system is further operative to perform a plurality of sampling runs on the sample material and to vary an amount of sample delivered to the processing chamber for each sampling run of the plurality of sampling runs. The system further operative to evaluate the analysis results for the plurality of sample amounts and to compare the evaluated analysis results with an expected relationship. If the evaluated analysis results match the expected relationship then analysis results corresponding to a largest volume of sample delivered for the plurality of sampling runs is identified as an optimum analysis result. If the evaluated analysis results do not match the expected relationship, additional sampling runs delivering smaller volumes of sample are performed to generate additional analysis results representative of the smaller volumes, and the additional analysis results are evaluated and compared until the additional analysis results match the expected relationship and a largest volume of sample delivered for the additional analysis runs is identified as the optimum analysis result.

In some embodiments, the system is operative to vary the volume of delivered sample by varying a volume of each sample delivered to the processing chamber. In some embodiments, the system is operative to vary the volume of delivered sample by varying a frequency of each sample delivered to the processing chamber such that for a higher frequency of sample delivery a plurality of delivered samples may be combined in the flowing stream of liquid to produce a higher concentration of sample delivered to the electrospray emitter.

In some embodiments, the sample material comprises a liquid sample material and the measured volumes of sample from the sample material comprise sample droplets ejected from the liquid sample material.

In some embodiments, the sample material comprises a solid sample material and the measured volumes of sample from the sample material may be varied by controlling an immersion time for the solid sample material to remain immersed in a solvent. In some aspects the solvent comprises the liquid flowing through the processing chamber.

In some embodiments, the measured volumes of sample may be varied by controlling a composition of the flowing stream of liquid in contact with the sample material in the processing chamber. In some embodiments, the measured volumes of sample may be varied by controlling a flow rate of the flowing stream of liquid in contact with the sample material in the processing chamber.

In some embodiments the system is operative to vary a flowrate of the nebulizer gas based on the analysis results.

In some embodiments, the system is further operative to determine a relationship between the amount of sample injected and signal produced in the mass spectrometer responsive to the sample ions received and compares it to a known normal, i.e. expected, relationship. In some aspects, the system is further operative to adjust an amount of sample delivered to the processing chamber if the signal does not match the known normal relationship. In some aspects, the system is further operative to operative to adjust a frequency of sample delivered to the processing chamber if the signal does not match the known normal relationship. In some aspects, the sample comprises a liquid sample droplet and wherein the system is further operative to adjust a frequency of delivering the liquid sample droplets to the processing chamber if the signal does not match the known normal relationship. In some aspects, the system is further operative to adjust a flow rate of the liquid stream if the signal does not match the known normal relationship. In some aspects, the system is further operative to adjust the nebulizer gas flow rate if the signal does not match the known normal relationship. In some aspects, the system is further operative to adjust an amount of time a solid sample material is in contact with the flowing stream of fluid in the processing chamber to another value if the signal does not match the known normal relationship. In some aspects, the system is further operative to adjust a composition of the flowing liquid stream flowing through the processing chamber in contact with a solid sample to another if the signal does not match the known normal relationship. In some aspects, the flowing liquid stream comprises a solvent, and the composition comprises at least one of a concentration, a temperature, a solvent type, or an additive to the solvent.

In some embodiments a method is provided for adjusting a composition of the charged droplets that create gas phase ions to compensate for samples whose composition is outside the boundaries of those required for optimal ion production by: creating sample droplets from a liquid sample, introducing said sample droplets into a flowing stream of liquid, diluting said sample droplets in said flowing stream of liquid from 100 to 10,000 fold, and introducing the flowing stream of liquid and said diluted sample droplets into an electrospray ionization mass spectrometer to obtain a signal representative of components of the sample.

In some aspects the method increases the amount of the sample introduced by increasing the sample droplet volume and determines the relationship between amount of sample introduced and the mass spectrometer signal. In some aspects the method increases the amount of the sample introduced by increasing the frequency of sample droplet introduction determines the relationship between amount of sample introduced and the mass spectrometer signal. In some aspects the method compares the relationship between the amount of sample introduced and the mass spectrometer signal to a calibration curve of sample amount versus signal predetermined under solution composition conditions for ideal ion production from charged droplets. In some aspects the method decreases the amount of sample introduced by lowering the droplet volume until the relationship between the amount of sample introduced and the mass spectrometer signal is equivalent to that of an ideal calibration curve of sample amount versus signal. In some aspects the method decreases the amount of sample introduced by lowering the frequency of sample droplet introduction until the relationship between the amount of sample introduced and the mass spectrometer signal is equivalent to that of an ideal calibration curve of sample amount versus signal. In some aspects the method increases the transport fluid flow until the relationship between the amount of sample introduced and the mass spectrometer signal is equivalent to that of an ideal calibration curve of sample amount versus signal.

In some embodiments systems and methods are provided for analyzing an eluting liquid. In some aspects, the eluting liquid may be delivered from a liquid separator as a metered amount continuously delivered over a separation period. In some aspects, the systems and methods comprise: processing a sample material in a liquid separator having an inlet for accepting the sample material and an outlet for eluting separated components of the sample material; delivering the eluting separated components of the sample material as sample to a processing chamber; a flowing stream of liquid flowing through the processing chamber receiving and capturing the delivered sample. A transport conduit is provided to convey the flowing stream of liquid and captured sample to an electrospray emitter with a high electric field at a discharge end. The flowing stream of liquid comprising a solvent for diluting the captured sample. In some aspects the diluting is in the range of 100 to 10,000-fold. The electrospray emitter operative to discharge the flowing stream of liquid and diluted sample at the discharge end in the form of charged sample droplets. A flow of expanding gas is directed to surround the discharge end of the electrospray emitter creating a pressure drop at the discharge end and converting the charged sample droplets into sample ions. A mass analysis device operative to receive and analyze the sample ions and to produce analysis results representative of the delivered sample.

In some aspects, the liquid separator comprises a liquid chromatograph (LC) device. In some aspects, the liquid separator comprises a capillary electrophoresis (CE) device.

In some aspects, the dilution factor provided by the flowing stream of liquid may be pre-calculated based on an expected eluant flow rate from the liquid separator and a composition of the eluant.

In some aspects of the systems and methods, the system may be further operative to adjust a flow rate of at least one of the eluting separated components of the sample material and the flowing stream of liquid, and to compare the analysis results at the differing flow rates with a known relationship. In some aspects, if the analysis results do not match the known relationship, the system may be further operative to adjust the flow rate of the at least one of the eluting separated components of the sample material and/or the flow rate the flowing stream of liquid until the analysis results match the known relationship. In some aspects, if the analysis results do not match the known relationship, the system may be further operative to decrease the flow rate of the at least one of the eluting separated components of the sample material and/or increase the flow rate the flowing stream of liquid until the analysis results match the known relationship.

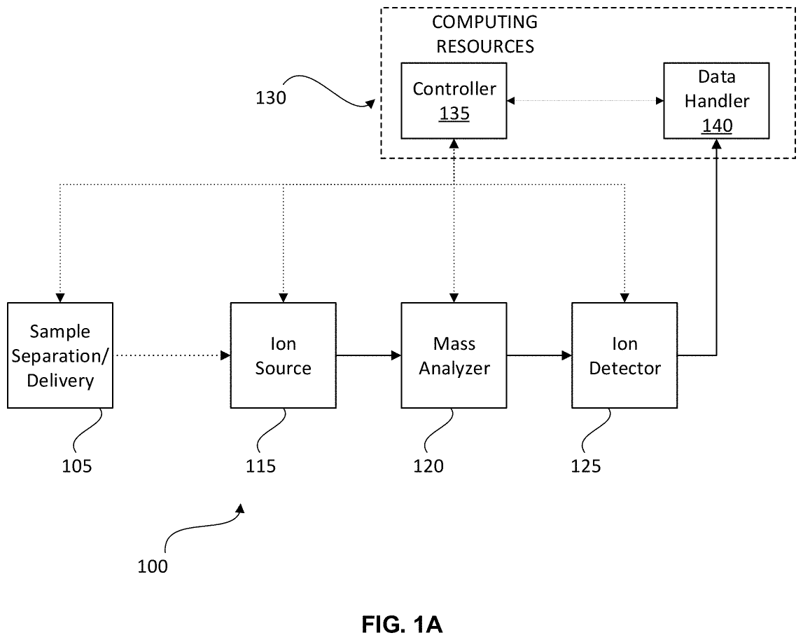

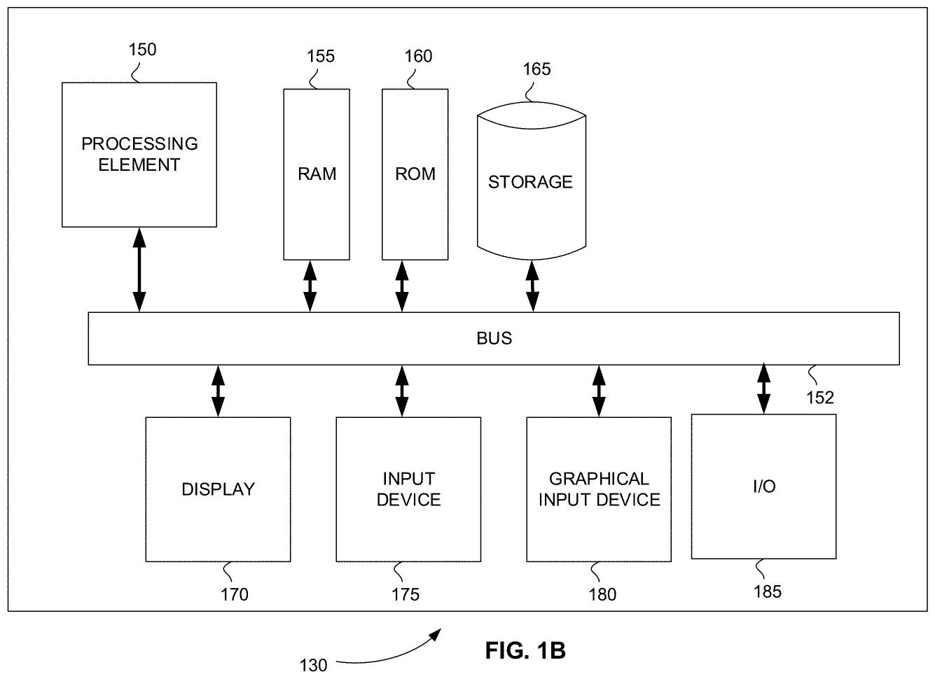

FIG. 1A presents, an exemplary mass analysis system 100 according to various embodiments of the present teachings. The mass analysis system 100 is an electro-mechanical instrument for separating and detecting ions of interest from a given sample. The mass analysis system 100 includes computing resources 130 to carry out both control of the system components and to receive and manage the data generated by the mass analysis system 100. In the embodiment of FIG. 1A the computing resources 130 are illustrated as having separate modules: a controller 135 for directing and controlling the system components and a data handler 140 for receiving and assembling a data report of the detected ions of interest. Depending upon requirements the computing resources 130 may comprise more or less modules than those depicted, may be centralized, or may be distributed across the system components depending upon requirements. Typically, the detected ion signal generated by the ion detector 125 is formatted in the form of one or more mass spectra based on control information as well as other process information of the various system components. Subsequent data analysis using a data analyzer (not illustrated in FIG. 1A) may subsequently be performed on the data report (e.g. on the mass spectra) in order to interpret the results of the mass analysis performed by the mass analysis system 100.

In some embodiments, mass analysis system 100 may include some or all of the components as illustrated in FIG. 1A. For the purposes of the present application, mass analysis system 100 can be considered to include all of the illustrated components, though the computing resources 130 may not have direct control over or provide data handling to, the sample separation/delivery component 105.

In the context of this present application, a separation/delivery system 105, comprises a delivery system capable of delivering measurable amounts of sample, typically a combination of analyte and accompanying solvent sampling fluid, to an ion source 115 disposed downstream of the separation system 105 for ionizing the delivered sample. A mass analyzer 120 receives the generated ions from the ion source 115 for mass analysis. The mass analyzer 120 is operative to selectively separate ions of interest from the generated ions received from the ion source 115 and to deliver the ions of interest to an ion detector 125 that generates a mass spectrometer signal indicative of detected ions to the data handler 140.

It will also be appreciated that the ion source 115 can have a variety of configurations as is known in the art. The present application is mainly directed towards ionization sources that operate by ionizing sample in droplet form, such as the electrospray process.

For the purposes of this application, components of the mass analysis system 100 may considered to operate as a single system. Conventionally, the combination of the mass analyzer 120 and the ion detector 125 along with relevant components of the controller 135 and the data hander 140 are typically referred to as a mass spectrometer and the sample separation/delivery device may be considered as a separate component. It will be appreciated, however, that while some of the components may be considered “separate”, such as the separation system 105 all the components of a mass analysis system 100 operate in coordination in order to analyze a given sample.

FIG. 1B is a block diagram that illustrates exemplary computing resources 130, upon which embodiments of the present teachings including the mass analysis system 100 may be implemented. The computing resources 130 may comprise a single computing device, or may comprise a plurality of distributed computing devices in operative communication with components of a mass analysis system 100. In this example, computing resources 130 includes a bus 152 or other communication mechanism for communicating information, and at least one processing element 150 coupled with bus 152 for processing information. As will be appreciated, the at least one processing element 150 may comprise a plurality of processing elements or cores, which may be packaged as a single processor or in a distributed arrangement. Furthermore, in some embodiments a plurality of virtual processing elements 150 may be provided to provide the control or management operations for the mass analysis system 100.

Computing resources 130 also includes a volatile memory 150, which can be a random access memory (RAM) as illustrated or other dynamic memory component, coupled to bus 152 for use by the at least one processing element 150. Computing resources 130 may further include a static, non-volatile memory 160, such as illustrated read only memory (ROM) or other static memory component, coupled to bus 152 for storing information and instructions for use by the at least one processing element 150. A storage component 165, such as a storage disk or storage memory, is provided and, is illustrated as being coupled to bus 152 for storing information and instructions for use by the at least one processing element 150. As will be appreciated, in some embodiments the storage component 165 may comprise a distributed storage component, such as a networked disk or other storage resource available to the computing resources 130.

Optionally, computing resources 130 may be coupled via bus 152 to a display 170 for displaying information to a computer user. An optional user input device 175, such as a keyboard, may be coupled to bus 152 for communicating information and command selections to the at least one processing element 150. An optional graphical input device 180, such as a mouse, a trackball or cursor direction keys for communicating graphical user interface information and command selections to the at least one processing element 150. As illustrated, the computing resources 130 may further include an input/output (I/O) component 185, such as a serial connection, digital connection, network connection, or other input/output component for allowing intercommunication with other computing components and the various components of the mass analysis system 100.

In various embodiments, computing resources 130 can be connected to one or more other computer systems a network to form a networked system. The network can include a private network or a public network such as the Internet. In the networked system, one or more computer systems can store and serve the data to other computer systems. The one or more computer systems that store and serve the data can be referred to as servers or the cloud, in a cloud computing scenario. The one or more computer systems can include one or more web servers, for example. The other computer systems that send and receive data to and from the servers or the cloud can be referred to as client or cloud devices, for example. Various operations of the mass analysis system 100 may be supported by operation of the distributed computing systems.

Computing resources 130 may be operative to control operation of the components of the mass analysis system 100 though controller 135 and to handle the data generated by the components of the mass analysis system 100 through the data handler 140. In some embodiments, analysis results are provided by computing resources 130 in response to the at least one processing element 150 executing instructions contained in memory 160 or 165 and performing operations on data received from the mass analysis system 100. Execution of the instructions contained in memory 155, 160, 165 by the at least one processing element 150 render the mass analysis system 100 operative to perform methods described herein. Alternatively, hard-wired circuitry may be used in place of or in combination with software instructions to implement the present teachings. Thus, implementations of the present teachings are not limited to any specific combination of hardware circuitry and software.

In accordance with various embodiments, instructions configured to be executed by a processing element 150 to perform a method, or to render the mass analysis system 100 operative to carry out the method, are stored on a non-transitory computer-readable medium accessible to the processing element 150.

In some embodiments, systems and methods are described to dynamically measure and adjust the physical chemical conditions in charged droplets for optimum gas phase ion production for electrospray mass spectrometry. Non-optimal ion production is generally referred to as ionization suppression. The mass analysis system 100 is operative to detect when ionization suppression is occurring, that is when the composition of the highly charged nanodroplets created during the electrospray process operating on the delivered sample begins to limit the rate of ion production and to introduce nonlinearities in the relationship between analyte concentration in the sample and response signal generated by the mass analysis system 100.

In some embodiments, the systems and methods are operative to detect when ion production by the ionization source is suppressed beyond a pre-determined threshold or completely shut off as a result of conditions in the droplets. The systems and methods may include an alarm condition indicative of the detected ion suppression or lack of ion production which may be presented in association with mass analysis results produced by the mass analysis system 100.

In some embodiments, the systems and methods are operative to introduce corrective measures to modify the composition of the droplets produced during the electrospray process in the ionization source to return operation of the ionization source to conditions where a linear relationship between concentration of delivered sample and response generated by the mass analysis system 100 is achieved.

High concentrations of analyte provided in the delivered sample may introduce non-linearities during the quantitation process. High concentrations of endogenous materials in the delivered sample, such as from biological and other sources, particularly those with surface active properties, crowd the surface of the charged droplets produced by the electrospray process which inhibits or prevents the liberation of lower concentration ions of interest that may be trapped in the interior bulk fluid. High concentrations of endogenous materials in the delivered sample will result in the formation of solid charged residues effectively trapping the molecular components of the sample in the droplet and preventing gas-phase ion production of those trapped molecular components. As a result of the sub-optimum ion generation a mass analysis system will be unable to accurately detect and/or characterize all of the components of a delivered sample, a phenomenon commonly referred to as ion suppression.

As a result of this issue, standard practice is to perform extensive sample preparation before delivery in order to ensure concentrations of endogenous materials in the delivered sample will not lead to ion suppression during the ionization process due to high solute concentrations. Standard practice is to also perform sample preparation before delivery to purify the sample and remove matrix components which may lead to a “matrix effect”, i.e. ion suppression due to characteristics of the matrix components.

In embodiments, systems and methods are provided for receiving unadulterated samples and automatically adjusting a composition of sample delivered to an ionization source in order to ensure ion suppression is not taking place during ionization by the ionization source.

In some embodiments, systems and methods are operative to adjust a concentration of solutes in the delivered sample before delivery to an ionization source such that droplets produced by the ionization source have sufficiently low concentration of solute to avoid ion suppression. In these cases, with sufficiently low concentration of solute in the droplets access to the droplet surface is provided to the low concentration analytes such that the high electric fields at the droplet surface induce field ion emission of charged molecules of the low concentration analytes from the liquid to the gas phase for mass spectrometric analysis. In aspects, the process of detecting and correcting for ionization suppression may occur in near real-time fashion consuming low nanoliter volumes of sample. As a result, these systems and methods circumvent the requirement for manual sample dilution and purification prior to introduction into a sample delivery component of an electrospray ionization mass spectrometer.

It is crucial for any chemical measurement device to be able to provide a response that is reproducibly proportional to the amount of material being measured to obtain accurate and precise determinations of the quantity of material present. In the case of mass spectrometry, the relationship between ion count at the mass spectrometer detector and the gravimetric mass of analyte in the sample with electrospray ionization has been extensively studied and empirically determined to have a linear dynamic range of approximately 10³-10⁴. The linearity of the relationship is maintained as the sample concentration gets lower, i.e. no limits to dynamic range are imposed by lower numbers of molecules available for analysis in the sample other then there are too few to be detected. The implications of this are as the creation, transmission, and detection of ions becomes more efficient (improvements in sensitivity and signal-to-noise) the linear dynamic range is also improved. Ionization suppression only imposes limitations on the ionization process at the high end of the linear dynamic range.

Fundamental limits to the linear dynamic range are imposed by high concentrations of analyte and/or high concentrations of other extraneous chemicals in the sample solution are commonly referred to as endogenous or matrix components in the biological disciplines. This is a result of a modification of both the colligative and chemical properties of the fluids entering the ion source in the sample and in terms of the effect on mass analysis system response both causes are referred to as ionization suppression.

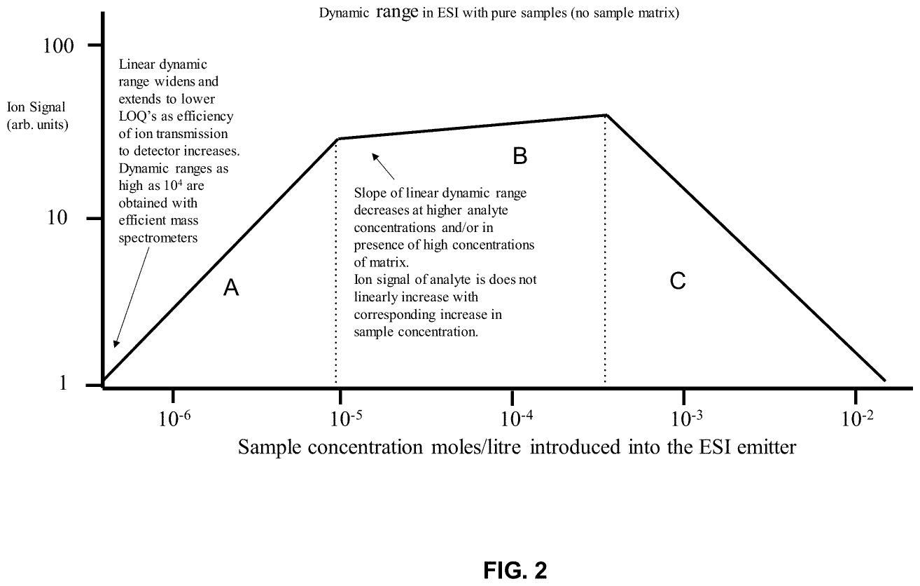

FIG. 2 is a simplified plot illustrating the classically understood electrospray sample concentration versus signal response relationship for a purified sample fluid without a matrix component. FIG. 2 illustrates an idealized relationship to illustrate that at low analyte concentrations, typically below about 10⁻⁵ M in a relatively pure sample (Region A), the signal response to sample concentration is linear. The linear relationship typically holds across analyte concentrations of about 3 to 4 orders of magnitude depending upon the the lowest levels of detectable analyte concentrations which are defined by the lowest limit of detection of a system. The lower the limit of detection (LoD) the broader the measurable linear dynamic range. Accordingly, the effective linear dynamic range of a mass analysis system may widen and extend to lower limits of quantitation (LoQ) with increased efficiency of ion transmission to the system detector. Dynamic ranges as high as 10⁴ are obtained with efficient mass spectrometers that are able to detect lower ion signals. At the limit, the sensitivity of the detector is counterbalanced with noise and so it is still desirable in many cases to increase ion signal to improve overall S/N.

At a concentration of about 10⁻⁵ M for the analyte of interest the signal increase with increasing concentration levels off (Region B), i.e. the slope of signal increase to sample concentration decreases. Typically, the relationship between signal and concentration in Region B may start to move into a non-linear relationship as the suppression effect increases with increasing concentration. The ion signal of analyte does not linearly increase with corresponding increase in sample concentration in Region B due to competition for surface sites on the periphery of the high field ion emitting droplet. This phenomenon is understood from Enke's equilibrium partition model and Bruins' experimental observations.

The linearity levels out when analyte concentrations, or other competing compounds in solution, reach about 10⁻⁵ M. Above analyte concentrations of 10⁻⁴ M the severe suppression region is entered where either its or the concentrations of other components continues to increase. While not illustrated in FIG. 2, in some cases in the latter portion of region B the response may remain constant even with increasing analyte concentration. At a point above about 10⁻⁴ M the slope of the calibration curve becomes negative as shown in FIG. 2 (Region C). In this region of severe suppression the signal response decreases with increasing analyte concentration until, at some point, full suppression of response signal occurs.

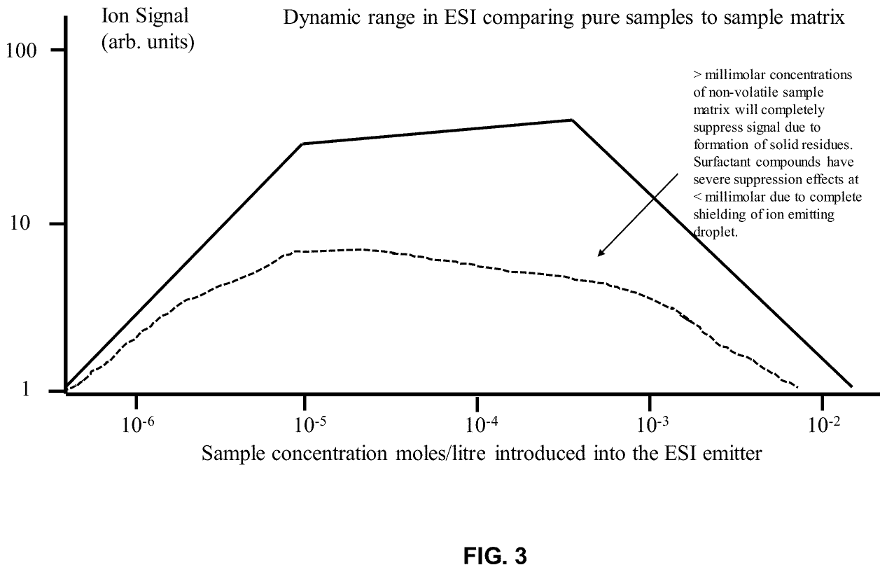

FIG. 3 is a simplified plot that compares the idealized plot of FIG. 2 to a simplified mass analyzer signal response that suffers from ion suppression due to the additional effect of sample matrix in the analyzed sample. In general, the presence of a sample matrix will have the effect of lowering the maximum detectable ion signal for a given sample and may have additional suppression effects. This effect, known as the matrix effect, can occur when typically greater than millimolar concentrations of non-volatile sample matrix is included in the sample. The sample matrix can completely suppress signal due to formation of solid residues. Surfactant compounds in particular have severe suppression effects at lower than millimolar concentrations due to complete shielding of the ion emitting droplets.

Ionization suppression is insidious in nature because its occurrence is unpredictable from sample to sample if samples vary in their composition which is almost always the case in biological systems. The complete composition of biological and other samples for analysis is never fully understood a priori. Sample purification methods such as solid phase extraction, liquid-liquid extraction, and liquid chromatography can help reduce its occurrence but not eliminate it. This is largely because to remove the offending sample components their chemical nature must be understood ahead of time to selectively optimize the purification method.

When analyte concentrations are outside the linear dynamic range or extraneous sample components are present causing ionization suppression it is desirable to know, when the sample is being analyzed, if ionization suppression is occurring and correct conditions to account for the deviation from the linear calibration. Methods to do this are primarily after-the-fact, ie after the analysis is complete and deviations from linearity are observed action is then taken and the analysis repeated to see if the corrections to the method improved the accuracy and precision of the analysis.

Ionization suppression is typically addressed by the use of extensive sample pre-purification protocols including solid phase extraction, liquid-liquid partitioning, antibody affinity pull downs of targeted components, and high-performance liquid chromatography. Determining whether a purification procedure will solve the suppression problem requires conducting test experiments using the protocol and iteratively adjusting and fine tuning the separations protocols until the suppression problem can be proven to be eliminated. The work by King describes this situation and its implications clearly. He devised an approach for determining where in an HPLC chromatogram regions of high ionization suppression occur due to contaminants co-eluting with analytes. King's methods serve as an aid to experienced analytical scientists who are customizing sample extraction procedures and chromatographic separations for specific analytes and biological matrices. This approach is time consuming, requires expertise, and is empirical by nature nevertheless it represents the state-of-the-art at this time. In many application areas where expertise and time are key determinants, for example clinical hospital laboratories, advanced analytical techniques of these types can be burdensome. Also these methods do not provide a route to the direct analysis of samples without pre-purification which in many cases distorts the chemical composition of the sample to be analyzed in unknown ways.

If samples are not sufficiently purified by HPLC or other means the linear dynamic range shifts to higher analyte concentrations. In presence of 10⁻⁵ M concentrations of matrix the signal of analyte is reduced. Competition for surface sites on the periphery of the high field ion emitting droplet. At concentrations greater than millimolar non-volatile sample matrix will completely suppress signal due to formation of solid residues. Surfactant compounds have severe suppression effects at <millimolar due to complete shielding of the ion emitting droplet. (see, for instance, Enke's equilibrium partition model and Bruins experimental observations).

Although there are variations in these values depending on the chemical characteristics of the analyte, the presence of other dissolved solutes, and the nature of the supporting solvent, these concentration mileposts remain remarkably consistent. The root causes of ionization suppression reside in both the chemical properties of the system and its physical state. The surface tension and viscosity of liquids and surface activity, solubility, and ionic character of compounds will vary from situation to situation introducing an element of unpredictability for the onset of ionization suppression. The physical state of the sample that defines the conditions under which ion production can occur are constants involving critical electric field strengths and colligative properties defining whether a system is in the solid or liquid state.

The role that the chemical and physical properties of the system play in the ionization suppression phenomena can be explained from the basic tenants of ion evaporation theory as will be described. Components of the sample in solution other than the analyte will lower the signal from the compound of interest at concentrations in the non-linear range. If the concentration of the endogenous compounds is high enough eradication of all signal from the sample will occur. Compounds having surfactant properties have a dominant effect over all other chemical species.

Embodiments of the present systems and methods enable the analysis of raw samples unmodified by sample purification or chromatographic separation by assessing the degree of suppression occurring and taking appropriate measures in an immediate real time fashion too correct the conditions for ion production and proceed with the sample analysis in an automated uninterrupted fashion. In order to ameliorate the suppression problem intervention in the process of ion production must have the net effect of creating conditions for optimal ion production at the stage when ions are produced.

Some embodiments of the present system and methods enable the analysis of eluant produced by a liquid separator without additional purification procedures. These embodiments, may be useful, for instance, where an LC or CE buffer may be considered incompatible with analysis by mass spectrometry. As an example, some buffers may contain surfactants which may lead to severe suppression effects using conventional techniques.

### Mechanism of Ionization Suppression

There are three sequential steps involved in the ionization process. The first involves the charging of the bulk liquid with an excess of positive or negative charge followed by the creation of the initial aerosol of charged droplets from the liquid using electric fields or pneumatic shear forces. The rapid evaporation of these droplets leads to their disintegration into smaller charged droplets as the local electric field reaches the Rayleigh limit, step 2. As their size further diminishes to a few tens of nanometers in diameter the electric field at the surface exceeds the solvation energy of the compounds in solution thereby expelling or ‘evaporating” the ions into the gas phase, step 3.

It is appropriate to examine in detail the mechanisms driving each and rationalize whether or not it is possible high concentrations of sample components can alter the processes of each in such a way as to cause ionization suppression.

### Stage 1. Charging the Bulk Fluid and Initial Charged Droplet Production.

The bulk fluid charging and subsequent droplet charging is a process similar to that of an electrolytic cell. When an electric field is created between an anode and cathode by a power supply that delivers or removes electrons from the electrodes ions are formed in abundance migrating in the solution bridging them. In the special case of electrospray there is not a continuous fluid between the electrodes but rather an air gap through which charges in the form of ions in droplets must jump. The charges migrate to the anode or cathode within the charged droplets containing the excess charge traveling through air rather than migrating through a continuous fluid between them. The entrance to the mass spectrometer ion optics is chosen to be either the anode or cathode depending on the polarity of the ions desired for analysis and is where the vacuum system draws a portion of the migrating ions into the mass analyzer. The other is typically a tube through which the liquid flows and from which the droplets are created. A small outer diameter of the tube assists in creating the high field from the applied voltage.

To create an excess of positive charge in the liquid a positive voltage relative to the mass spectrometer entrance, typically a few thousand volts, is applied which extracts electrons and oxidation reactions occur at the metal-liquid interface. For example, water is oxidized to oxygen gas and hydrogen ions (protons). To create an excess of negative charge a negative potential is applied, and reduction reactions occur such as the reduction of water to hydrogen gas and hydroxide ions. The electrolytic processes leading to the production of excess charge in the bulk solution have been extensively studied by Van Berkel and Kebarle.

Spray currents indicate the amount of charge transferred to the bulk liquid which are typically in the low uA range. As the fluid flow rate is increased the spray current rises roughly proportionally indicating that the charge density is the same at low and high flows and that the solvent has attained charge saturation. When electrolytes or other charge carrying components such as endogenous sample components are added to the fluid the spray current increases and so also does the charge density of the droplets formed. If ionization suppression were to be occurring at this stage, then the spray current would be observed to decrease. On the contrary the production of charged droplets is improved at this stage with the addition of charge carrying components to the sample which could take the form of salts or any ionizable organic molecule. This and other observations provide conclusive evidence that ionization suppression is not caused by a reduction of charge transferred to the liquid at this initial charged droplet formation stage. In practice it would only be in the rarest of cases that the composition of a sample would affect ion production by inhibiting the formation of the first stage of this ion production process.

Conductive Charging of the bulk liquid. When a high enough electric field is concentrated at the surface of a liquid charged droplets are launched from a protrusion forming at the surface in this location where the field is the greatest and travel through air to the counter electrode of the field. This point of droplet emission from the surface is referred to as the Taylor Cone. In the field of mass spectrometry using this process to create ions is commonly referred to as electrospray ionization.

Inductive Charging of neutral droplets. Some droplets separated from a bulk liquid by forces such as pneumatic nebulization, piezoelectric, or acoustic dispensing have a small net charge by statistical fluctuations in the number of charge carriers in different regions of the bulk solution during the droplet formation process. Gas phase ions are formed in clouds and near water falls by such a mechanism and the study of this process led to the elucidation of the IE model for ion production using an ion mobility analyzer to roughly size the ions produced. The number of droplets with a net charge can be increased by drifting them through a strong electric field created by grids or lenses at atmospheric pressure. The grids polarize the charge in the droplets which, upon disintegration, form more droplets having a net charge by this induction process. This approach was used to validate the theoretically derived IE model with a mass spectrometer to identify the ions produced and was then prototyped as an LC/MS interface. Subsequently when conductive charging of the liquid was introduced with electrospray and ion spray the difference in ion production efficiency became apparent between the inductive and conductive charging methods. The types of ions produced were identical as the mechanism for ion production is the same for all three but the average charge per initial droplet and number of droplets with any charge was found to be lower than charging by conduction.

Frictional charging of the bulk liquid prior to droplet formation can be done without a power supply by leveraging the triboelectric effect, which is a type of frictional charging. In this instance the liquid is passed across the surface of a metal conductor (steel tube of small inner diameter) and accelerated at the exit of the tube by a very high velocity gas. Momentary adhesion of molecules in solution to the electrode and exchange of charge during that time can result in the loss of electrons to the electrode when the molecules are swept away by the high velocity gas before recombination can occur. The net effect can be the production of high charge density sprays similar to the conductive charging approach but more difficult to control. A common term for this is Sonic Spray.

Initial charged droplet formation occurs soon after the bulk liquid is charged. The energy available from an electric field is limited by the electrical breakdown of the surrounding gas at atmospheric pressure. The energy available to create an aerosol by this means was established by Taylor in his original thesis on the topic where he described the formation of a fluid cone emanating from the bulk liquid at the point where the field is the greatest commonly referred to as the “Taylor Cone”. The cone dispensed charged droplets from its apex that on average are of micron to slightly sub-micron in diameter.

Based on the Taylor equation, the energy available compared to surface tension/viscosity of common solvent illustrates that even for those containing 10⁻³ M solutes there should be enough energy to create drops from even the worst ion suppressing samples indicating this is not where ion suppression takes effect.

The energy from the electric field is sufficient to disperse into aerosols commonly used solvents such as water and alcohols even when their viscosities are altered by most matrix compounds present at 10⁻³ M so ionization suppression inhibiting the initial charged droplet formation cannot be expected to be occurring at this stage unless dissolved solutes reduce the amount of charge that can be deposited in the bulk liquid. This is not the case as described below.

The utility of this approach is truncated by the maximum fluid flow from which a continuous aerosol of droplets can be sustained which is caused by limits to both the frequency and volume of droplets created by electric fields that must remain at sub-discharge values. In practice this is approximately 1 uL/min or less in fluid flow, commonly referred to as nanospray, which severely hampers it analytical applications which operate at flows between 1-1000 uL/min. For this reason, other energy sources were explored to create the droplets and pneumatic nebulization has become the dominate approach.

The energy available from a rapidly expanding high pressure gas is enormous and far exceeds any extremes of sample viscosities encountered in practice. The gas accelerates as it expands reaching sonic velocities within a distance of approximately 1 mm from the expansion nozzle. Considering the gas acceleration required to achieve this the G forces exceed 200,000 in this region. Any fluid entering this region is sheared into low micron diameter droplets instantaneously. This approach is termed Ion Spray because it is a hybrid of pure Electrospray (direct electrical field droplet production-Fenn-Gall) and Ion Evaporation (pneumatic droplet production with indirect electrical charging by induction-Thomson).

No sample conditions could have an effect on the outcome of this process. Ionization suppression does not exert its effect at this stage unless, as with the electric field nebulization approach, the sample composition can reduce the amount of charge deposition in the droplets which is required for the subsequent stages of the ionization process to be successful.

The force due the gas expansion is utilized for a secondary purpose in this invention. It is the driving force propelling the moving stream of fluid though the system from the point of droplet capture to the point of charged droplet formation.

Stage 2. Charged Droplet Disintegration.

At atmospheric pressure the charged droplets formed during stage 1 lose neutral solvent by evaporation. The rapidly increasing charge density of each droplet leads to the instability of the droplets as the internal electric field within each droplet exceeds the ability of the surface tension to hold intact a drop of this size, approximately 1 micron in diameter. Each of these droplets will have tens of thousands of charges. In manner of a few hundred microseconds they will reach the Rayleigh stability limit ( ) at which point the droplet will relieve itself of the excess charge in the form of smaller droplets of approximately one tenth of the original size to be spawned containing the requisite amount of charge to relieve the strain, that being on the order of a few hundred charges in each sibling droplet. The process repeats itself driven by the continued evaporation of the droplets and subsequent coulomb explosions. As the droplet diameter decreases the electric field at the surface increases as the radius of curvature decreases. The charge density increases as the droplets cascade to ever decreasing diameters.

It is conceivable that if the concentration of endogenous materials in the sample were high enough this process would be inhibited by the creation of solid charged residues entrapping analyte within. However, the concentrations of materials to effect this in droplets of 100 nm diameters is much greater than the observed 10⁻⁴ M. In addition, the strong chemical effect observed whereby highly surface active compounds can suppress ionization at lower concentrations does not follow. Surface active components lower the surface tension thereby enabling the Rayleigh limit to be more readily achieved.

There is not a clear explanation how the presence of endogenous materials in samples that suppress ion production could be affecting this charged droplet disintegration process except in extreme situations.

Stage 3. Gas Phase Ion Production.

The root cause of ionization suppression can be rationalized from an understanding of the fundamental principles of ion formation during electrospray. Two theories dominate the current scientific literature, the Ion Evaporation Model (IE model) and the Charged Residue Model (CR model). Both models share a key premise that being the final event leading to the production of gas phase ions or cluster ions from a bulk solution occurs from charged droplets that are on the order of 10 nm in radius. The effect of extraneous compounds causing the suppression event occurs at this stage or during the cascade of events immediately preceding it so intervention to ameliorate the problem must have its primary effect at this stage.

The solution to the problem described here can be rationalized from either model because this approach involves controlling the composition of the final ion producing droplets and of those immediately leading up to it for optimum ionization efficiency. The IE model more readily explains common empirically observed situations where ionization suppression occurs, particularly where chemical effects dominate such as in the presence of surfactants. This model will be used to explain the general approach taken here. In addition, it is generally recognized in the scientific literature that the IE model bears most merit for all compounds under a few thousand in molecular weight while the CR model has merit primarily only for very large extended protein molecules of tens to hundreds of thousand amu where the physical size of these molecules and their associated solvent clusters is on the orders of 10 nm. Since the vast majority of analyses are for compounds under a few thousand molecular weight the IEM is more relevant to explain the approach taken with this invention to control ionization suppression.

The primary condition that needs to be met for an ion to be liberated from the solution phase to the gas phase is for the local electric field in the droplet to exceed the solvation energy of the analyte molecule thereby expelling it from the liquid. This can be calculated to occur at a field strength of 1-3 V/nm which requires a droplet radius of approximately 10 nm containing around 10 elementary charges. Droplets of this size relieve their internal coulombic stresses by expelling ions instead of the charged droplets that larger evaporating drops eject when they reach the Raleigh limit.

Ions are expelled from the droplet surface where the electric field is concentrated around the radius. When the surface is completely occupied by analyte ions an increase in analyte concentration will not lead to an increase in the rate of ion evaporation from the droplet. Given the number of molecules in a 10⁻⁵M solution it is calculated that there is 5 nm² of space for each ion on the surface of these droplets. The radius of an average organic ion or molecule with C—C bond lengths of 0.15 nm is about 1 nm which would occupy a space of approximately 3 nm. The phenomena of ionization suppression is explained by the competition for space on the surface of the ion emitting droplets that have radii on the order of 10 nanometers and an internal electric field exceeding the solvation energy of organic molecules with one or more molecular charges.

Clusters of analyte ions and their neutral compatriots appear at the point when the linear dynamic range begins to level off and the molecular ion production rate slows down with increasing concentration. When the surface is completely occupied by endogenous matrix components analyte ion production drops with increasing concentration. Concentrations of greater than 10-4M eventually lead to the most severe manifestation of ion suppression where no signal from any components of the solution is observed at all. This is because the 10 nm radius droplet condition in never met. The evaporating droplet turns into a solid charged residue entrapping all available ions before reaching ion emission diameters and fields. These so-called “asteroids” have been directly observed and measured using a novel mass spectrometry scan function.

When the field strength at the surface exceeds free energy of solvation of the charged species in solution, be they atoms or molecules otherwise referred to as ions, they will be expelled freely into the surrounding gas often hydrogen bonded to a few solvent molecules and are referred to as ion clusters. This process underpins the current understanding of the mechanism by which ions are formed during electrospray. A few slight variations exist but they all depend on small high charge density droplets from which multiple ions in solution emit or, if the dissolved ions are massive and on the order in size of such a droplet, only one ion is present in the diminished droplet.

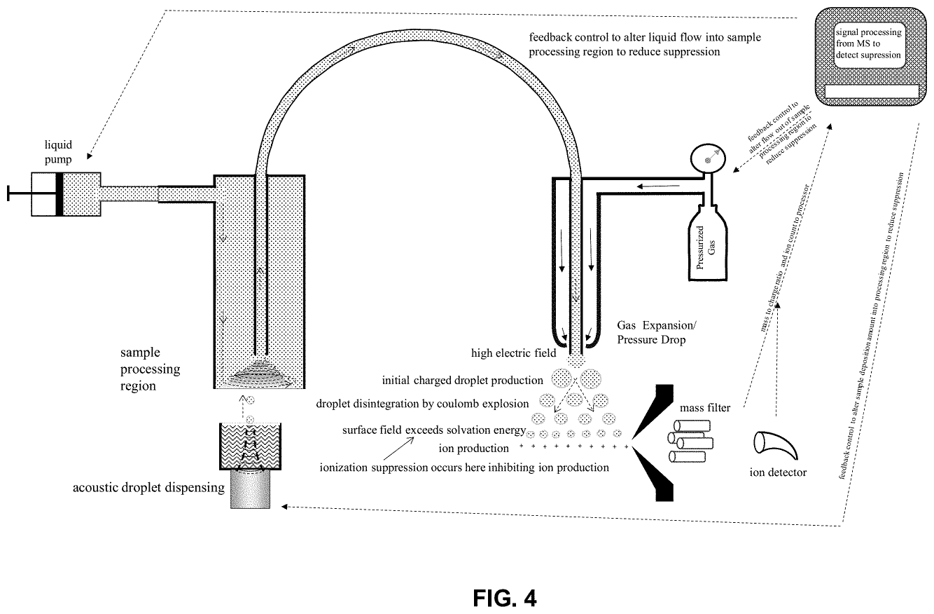

FIG. 4 depicts an embodiment of the invention that illustrates the five main components, each having different functions. The first is a sample delivery device whereby the amount of sample delivered can be controlled. In this embodiment the sample delivery is achieved by a burst of acoustic waves imparting energy into the surface of the fluid sample there by ejecting a droplet of known and controllable volume. The amount of sample entering the processing region, ie a sample processing chamber of a sample processing component, can be varied by changing the power, frequency, or duration of the acoustic wave pulse. By varying the amount injected the dilution of the sample in the processing region is changed. Other sample delivery devices are contemplated, including delivery of liquid samples by pneumatic or other ejection, liquid injection, liquid transfer under the influence of gravity, flowing liquid transfer, transfer of solid samples by physical transport, transfer of solid samples by immersion in the flow of liquid, and other known ways for delivering sample.

The second component is a sample processing region or chamber of a sample processing component where the samples are received, and the concentration of the sample is adjusted to be optimal for electrospray ionization. In this embodiment, the sample processing component includes a fluid delivery pump to provide the fluid for sample processing and transport. The flow of the transport fluid into this region can be varied with the pump thereby altering the degree of dilution of the sample and rate of transport. The volume of the sample processing region can also be changed by altering its geometry which will affect the amount of dilution the sample will encounter. This is an effective way to increase or decrease the dilution ratio but may require substitution of a physical part or additional mechanical linkage which may not be readily adaptable to rapid on-line modification of the dilution ratio in real time.

The third component comprises an ionization component which provides the facilities to create charged droplets from the processed sample including a gas expansion region to create a pressure drop to draw the samples from the processing region to the charged droplet generation region where a high electric field is applied. Application of the high electric field to the charged droplets converts the discharged sample droplets into sample ions. Control of this gas flow will allow one to vary the liquid flow out of the processing region thereby offering an additional manner to alter the degree of dilution in the processing region.

The fourth component is an atmospheric pressure ionization mass spectrometer for receiving sample ions, filtering the sample ions by m/z and measuring the quantity of ions created.

The fifth component is a computer equipped with data and algorithms for interpreting the generated signal and a communication link to the sample delivery device, the fluid delivery pump, and the pressurized gas source. After the signal is measured and the degree of ionization suppression is determined based on the generated analysis results, and the appropriate dilution of the sample is done by adjusting the sample delivery device parameters, fluid delivery pump flows, and/or the pressurized gas flow. In some aspects, if none of these actions are able to fully correct the suppression then system can calculate the volume required of a sample processing region to reach the required dilution and the sample processing region can be manually replaced.

The embodiment of FIG. 4 is useful because of its speed, reproducibly, and accuracy in delivering sample droplets of known and reproducible volume. In some aspects, the embodiment may further include a motion component for moving a sample well plate including a plurality of sample wells to position an intended sample well in alignment with the sample processing region. In some embodiments, the time required to position a sample well and acoustically fire into the processing chamber is on the order of tens of milliseconds per sample. Individual samples can be stacked in the transfer line between the processing chamber and point of ion production where their spacing in time is limited only by the diffusion of the molecules in solution in the pipe, typically on the order of a few hundred milliseconds in prototypes of this invention. This enables near real-time firing of a sample, detecting its signal, comparing to a reference to assess suppression, and re-firing an amount to provide the appropriate dilution in the processing chamber to provide the correct conditions in the ion emitting droplets for a linear analyte response and avoid suppression effects.

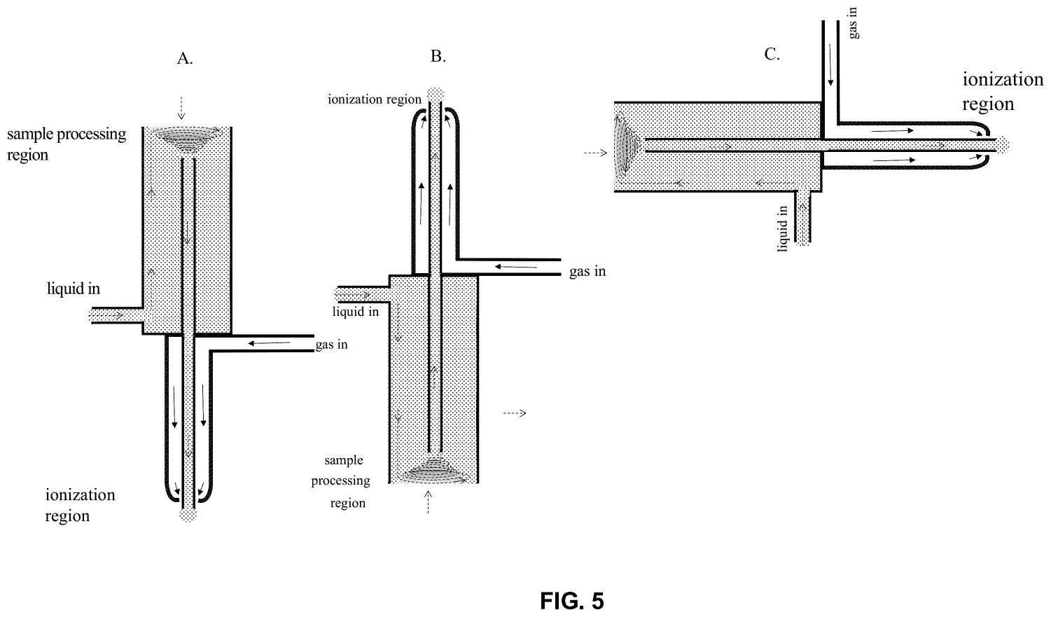

FIGS. 5A, 5B, and 5C depict different geometrical relationships between the components. FIG. 5A shows a sample processing component oriented vertically up and the charged droplet creation component oriented vertically down. This allows for samples to be deposited in a processing chamber of the processing component with gravitational or other forces. FIG. 5B shows the same two compartments oriented in opposite vertical directions. FIG. 5C shows both compartments horizontally configured. Any angles between the vertical and horizontal can be used if samples can be introduced into the processing region and the charged droplet generating component is oriented so that ions can arrive at the entrance aperture of the mass spectrometer by some method.

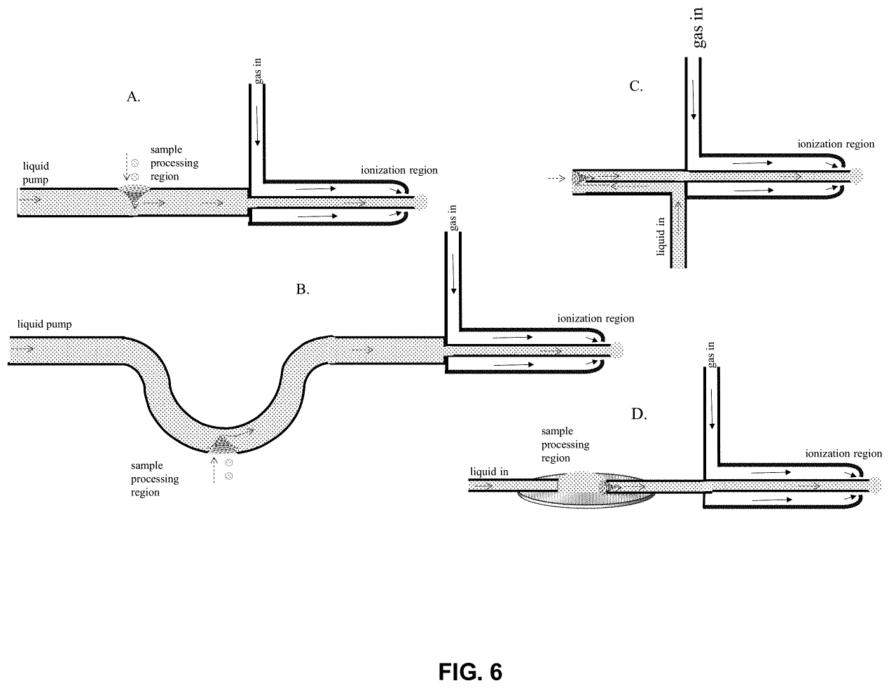

FIGS. 6 (A, B, C and D) show additional embodiments of the sample processing region that have fluid inlet and outlet tubes that are not co-axially arranged. FIG. 6(A)& FIG. 6(B) show a single tube, or 2 tubes butted, linearly arranged or bent, that have an opening to admit samples into the processing region. In some aspects, the processing chamber may comprise a single tube with an aperture exposing the processing fluid flowing through the tube. FIG. 6(C) shows an inlet and outlet tube that are arranged parallel to each other. FIG. 6(D) shows the two tubes co-linearly arranged with a gap between them to define then to create the sample processing region. In some aspects, a planar grooved surface may be provided to confine the fluid by coating the surface with a hydrophobic material. In some aspects, a processing region may be bound by no walls and only confined by the surface tension of the pooled liquid on a surface as it transports between the 2 tubes. Other embodiments for the processing region are also contemplated, such as the use of 2 tubes in near or far proximity to each other enclosed in the processing chamber. A processing chamber in the form of an open trough with a supply tube supplying processing fluid and an exhaust tube draining processing fluid from the trough.

In an embodiment sample droplets created by a gas pressure pulse forcing the sample droplet through an aperture in the sample well into a processing region. Nanoliter volume droplets can be dispensed and the volume introduced into the processing region controlled by the pressure, frequency, and duration of the pulse. Similarly, a syringe driven by a fast response motor or a piezo based dispenser can be used to deliver and vary the sample volumes entering the processing region. Larger volume dispensing devices such as pipettes can also be used as long as the volume dispensed, and the dilution ratio can be controlled in the processing chamber.

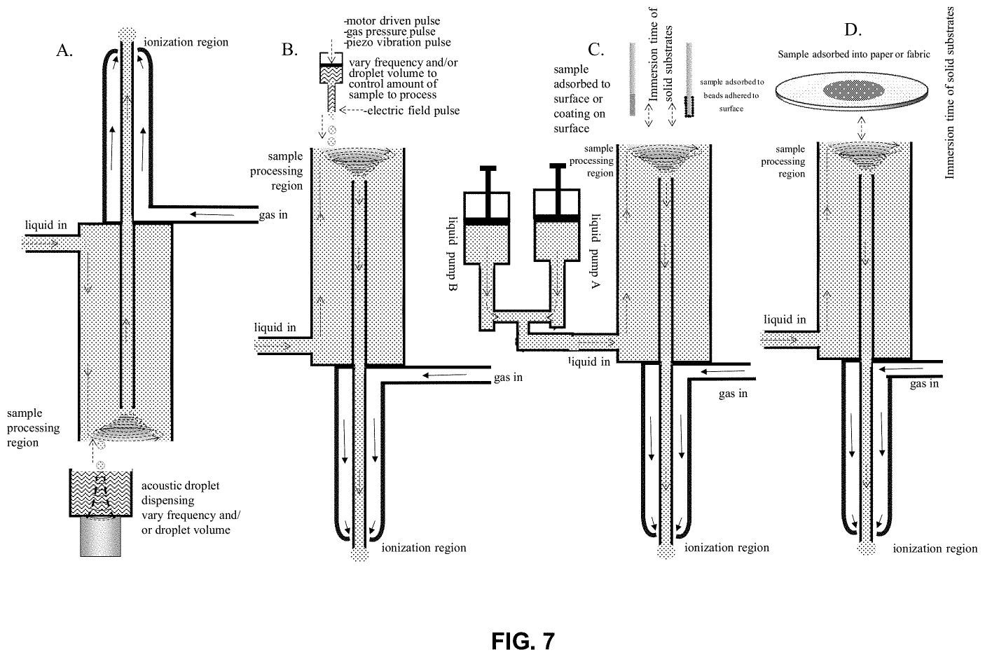

FIGS. 7 (A, B, C, and D) show exemplary embodiments of methods of sample introduction by a transport device included in this invention FIG. 7 (A) shows the launching of droplets into the processing region using acoustic energy transmitted through a sample well and focused on the surface. Sample droplets in the low nanoliter volume range are propelled into this region. Droplet volumes can be changed using different values of energy, frequency, or burst rate. Launching successive droplets at a high rate will coalesce them in the processing region before they transit to the ionization region. This is another method for altering the sample amount delivered to the ionization region.

FIG. 7 (B) shows the orientation of the sample processing region vertically to accept sample droplet introduction systems that operate more practically with the falling in the direction of gravity. One approach is to have holes on the order of tens of microns in diameter in the bottom of the sample containing wells and expelling sample droplets through the aperture with a gas pressure pulse applied to the sample reservoir. With this approach sample arrays can be presented to the system for analysis such as samples in microtiter well plates.

FIG. 7(B) also shows sample delivery options where the sample is dispensed through a tube of aperture by mechanical forces such as a syringe with the piston driven by a fast stepper motor or by using the vibrations of a piezoelectric element to create droplets. Droplets can also be created from the end of a tube held at a voltage such that the entrance to the processing chamber is at a sufficiently different voltage to create a high electric field between the two.

FIG. 7(C) shows the sample delivered to the processing region on the surface of a solid substrate. Disposable sampling devices made of glass, plastic, or wood for example can have coating that adsorb the components of the liquid sample such as blood. High porosity beads can be adhered to these sampling devices or attached with magnetic forces that can adsorb large amounts of targeted analytes from relatively large volumes of samples. Control of the amount released into the processing region can be done by controlling the amount of time the samples is exposed to the fluid in the processing region. Alternatively, the amount released can be controlled by altering the composition of the fluid in the processing region. A binary pump delivering the fluid to this region can adjust the composition in either a step or gradual gradient fashion to control the amount released and separate matrix components from the analytes because they would elute from the surface at different solvent compositions.

FIG. 7(C) depicts another way by which control of the amount of sample deposited into the processing chamber can be achieved when the sample is a solid or adsorbed to a surface. By adjusting the composition of the processing fluid with 2 or more pumps the elution strength can be modified to remove unwanted components and selectively elute the target compound. This effectively reduces the total sample load to the chamber in a controlled fashion. A more sophisticated version of this approach would be to deliver a gradual gradient of elution solvents of changing composition over time effectively minimizing the sample load during the ionization process. This has the added benefit of providing some chromatographic separation of sample components particularly important when isobars of the same mass are present and are indistinguishable with the mass spectrometer. All of the above can be altered in response to the signal from the mass spectrometer after comparing it to a sample where it is known suppression will not occur.

FIG. 7(D) is a variation on FIG. 7(C) where the solid sampling surface is a membrane or paper. A common way of sampling and storing blood for analysis is dried on paper. The paper can be used to directly deliver the sample to this system and control of the amount released by using either the variable elution time or variable elution solvent composition method.

Other embodiments for delivering sample are also contemplated, such as flowing a liquid sample for delivery by a transport device to the processing chamber.

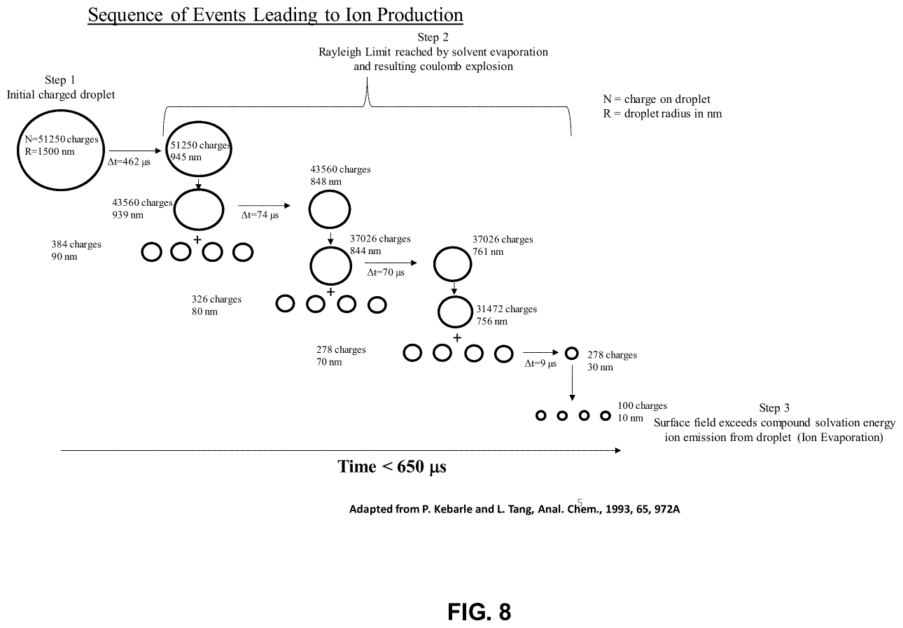

The sequence of events leading up to the creation of ions by the electrospray process is depicted in FIG. 8. The electrolytic charging and gas nebulization of the bulk fluid create the initial charged droplets. Sample composition has no measurable effect on these processes occurring on the bulk fluid, so the suppression of ion production is not in effect at this stage.

These droplets begin to evaporate and lose neutral solvent and other volatile components very rapidly thereby entering the next stage of the process. At the Rayleigh limit the internal electric field in each droplet exceeds the surface tension leading to its disruption and satellite charged droplet production with further evaporation and a cascade of coulomb explosions to relieve the enthalpy stresses. The stability of a drop is related to its radius and chemical composition. During this stage of the process the surface tension forces holding the droplet together are lower than the local electric fields surrounding each drop created by their internal charge and radius. The electric field forces available at the Rayleigh limit greatly exceed and stabilization of the droplet surface by dissolved components that increase its viscosity and surface-active properties in the 10⁻⁵M concentration and above. For this reason, suppression effects are not due to an interference in this coulomb explosion stage of the droplet size reduction process.

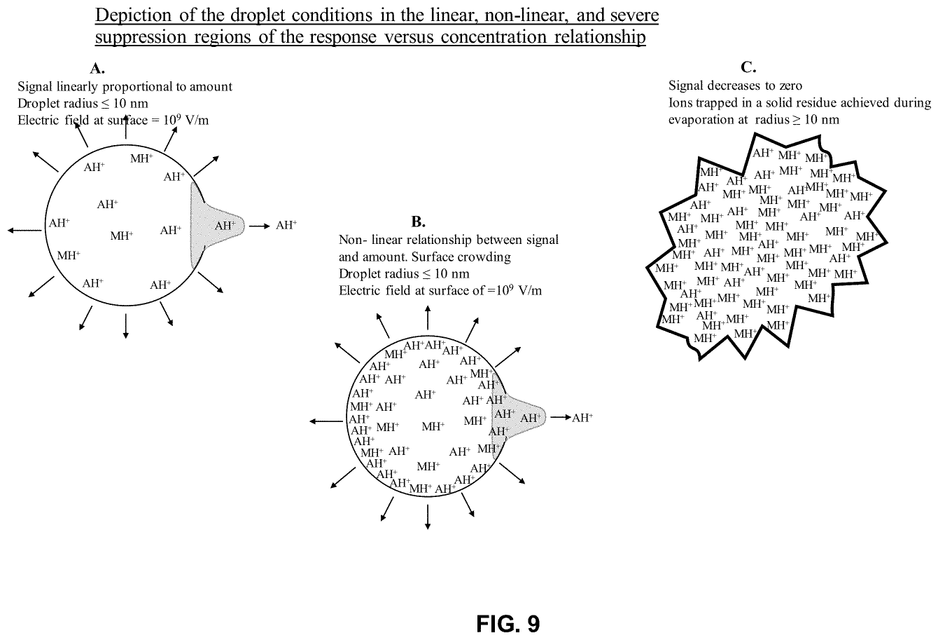

FIGS. 9 (A, B, & C) illustrate the physical state of the ion emitting droplets during the linear (Region A), non-linear (Region B), and suppression portions (Region C) of the dynamic range curve in FIG. 2. In the first instance the signal is linearly proportional to amount, the droplet radius is ≤10 nm and the electric field at surface=10⁹ V/m. Surface sites are vacant and become occupied as solute concentration increases. Under non-linear conditions the surface is crowded preventing a proportional increase in signal as concentration increases. During severe suppression the 10 nm droplet is not attained. The solute concentration is sufficiently high that a highly charged solid residue forms and no ions are emitted.

FIG. 9(A) depicts the solution conditions in the droplet when a linear response between analyte and amount occurs which is sub 10⁻⁵M. The droplets surface has available space for charged molecules to occupy. The processing chamber, in communication with the mass spectrometer signal and the sampling device, pumps, and gasses serves to maintain this ideal state during the analysis of samples.

FIG. 9(B) illustrates that at 10⁻⁴ M the surface is fully occupied and further increases in the internal concentration of analytes does not yield increasing signal. Surface active compounds are particularly effective at producing this state producing a barrier that other types of molecules cannot penetrate.

FIG. 9(C) illustrates at even higher concentrations the droplets begin to form solid residues prior to reaching ion emission conditions. Severe suppression occurs, ion production drops and is completely eliminated. Large charged residues with m/z ratios beyond the range measurable by mass spectrometers result but characterizing them has been a problem because of this. Recently a novel modification to a tandem quadrupole mass spectrometer has demonstrated the ability to detect and characterize these so-called asteroids proving their existence and adding definitive credence the theories surrounding the phenomena of ionization suppression (Schneider, Yang, Covey).

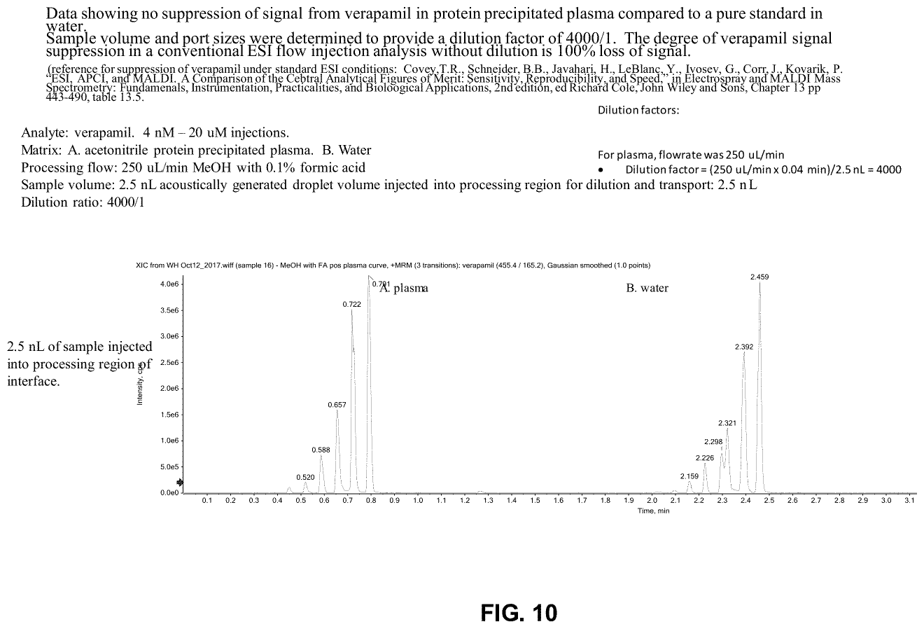

FIG. 10 is a comparison plot of trial analysis runs comparing sampling verapamil as an analyte in a complex biological sample, blood plasma in trial run A, with sampling the same analyte in pure water in trial run B. The dilution factor of the verapamil sample in the processing region by the processing flow (MEOH with 0.1% formic acid) for this embodiment is ˜4000×.

Trial run A presents data showing the lack of signal suppression from this system in the complex biological sample, blood plasma. In this example, the direct injection of unprocessed blood plasma into an electrospray ion source is expected to result in severe suppression effects. Common practice is to perform extensive purification and/or chromatographic separations in order to analyze blood plasma using an electrospray ion source. Unexpectedly, however, it is shown in FIG. 10 that the signal for reserpine is unaffected by the plasma matrix (Trial Run A) vis a vis a reference standard in water (Trial Run B). The dilution factor in the processing chamber and transport line was about 4000-fold moving the conditions in the ion emitting droplets from a point of surface saturation with endogeneous compounds to one where the surface sites remain unoccupied and available for the unobstructed emission of ions from the sample.

In the example of FIG. 10 (panel A), a plurality of sampling runs are implemented with increasing volumes of verapamil in a blood plasma matrix delivered for successive sampling runs. As illustrated, the ion signal detected for each sampling run increases in a generally linear response to increased blood plasma delivered for each sampling run. As a control, FIG. 10 (panel B) illustrates a plurality of sampling runs implemented using verapamil in water following the same protocol. As indicated the ion signal response for the sample without matrix illustrated in FIG. 10 (B) corresponds to the ion signal response generated for the sample with matrix illustrated in FIG. 10 (A). If there was a matrix effect caused by the increasing concentrations in FIG. 10 (A) it would be expected that the analysis results in FIG. 10 (A) (matrix) would illustrate a lower signal level then the analysis results generated in FIG. 10 (B) (no matrix).

From these results it can be observed that analyte concentrations are in the linear range with no evidence of suppression by comparing the detected ion signal for water versus signal from analyte in plasma.

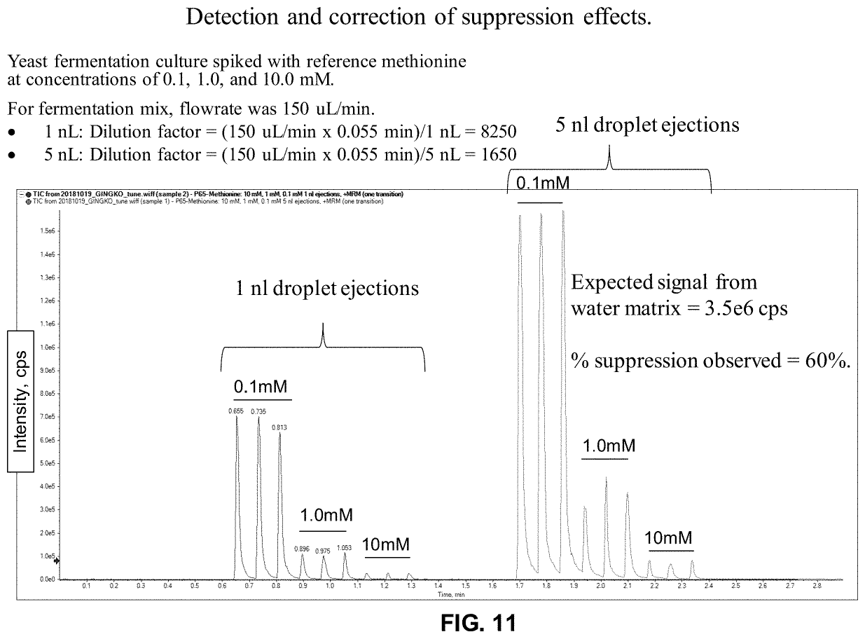

FIG. 11 is a plot of data illustrating the detection and correction of suppression effects in a fermentation broth media. The expected signal from a 5 nL injection of methionine is 40% of what is expected. The dilution ratio is 1650/1. Reinjecting 1 nL (e.g. 20% concentration) into the process region produces a signal equivalent to what is expected and 50% of the 5 nL signal instead of the expected 20%. Dropping the injection amount to 1 nL brings the signal back into the linear calibration region with a dilution ratio of 8250/1.

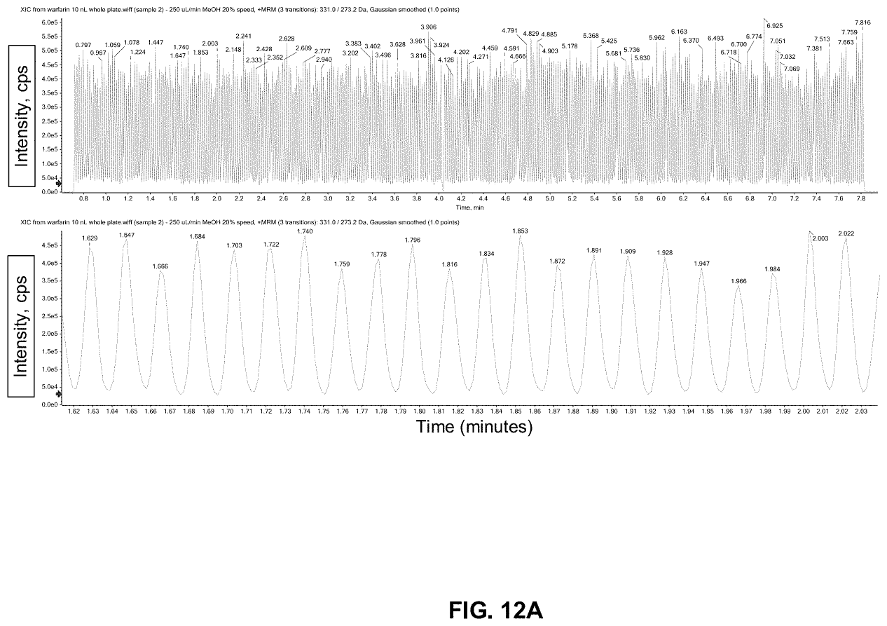

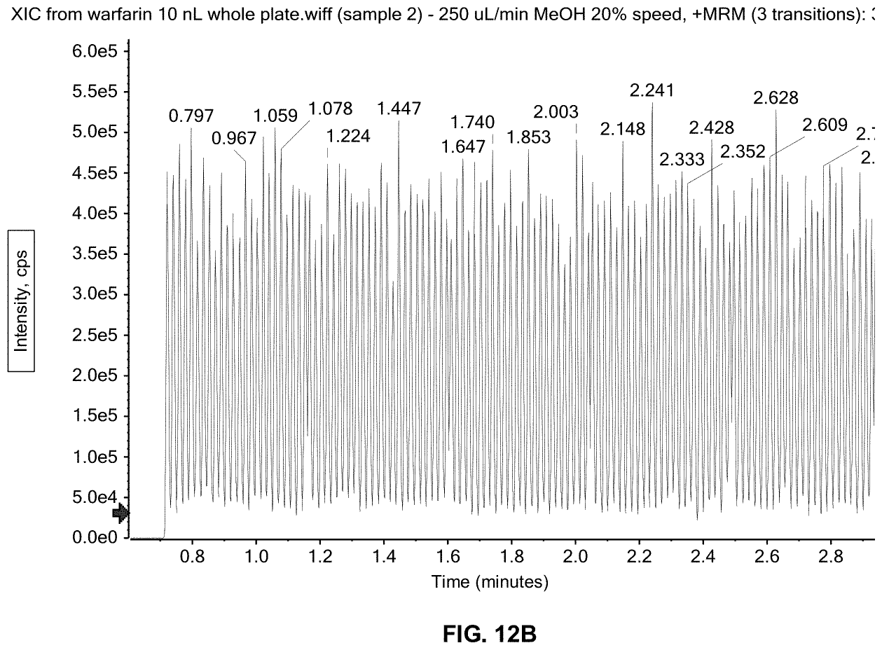

FIG. 12A is a plot of ion signal during sampling runs that illustrates the real time nature of this process. The per sample acquisition rate is <1 second. Detection and correction of suppression therefore occurs within a time frame of a few second times.

FIG. 12B is a closeup view of the analysis data presented in 12A.

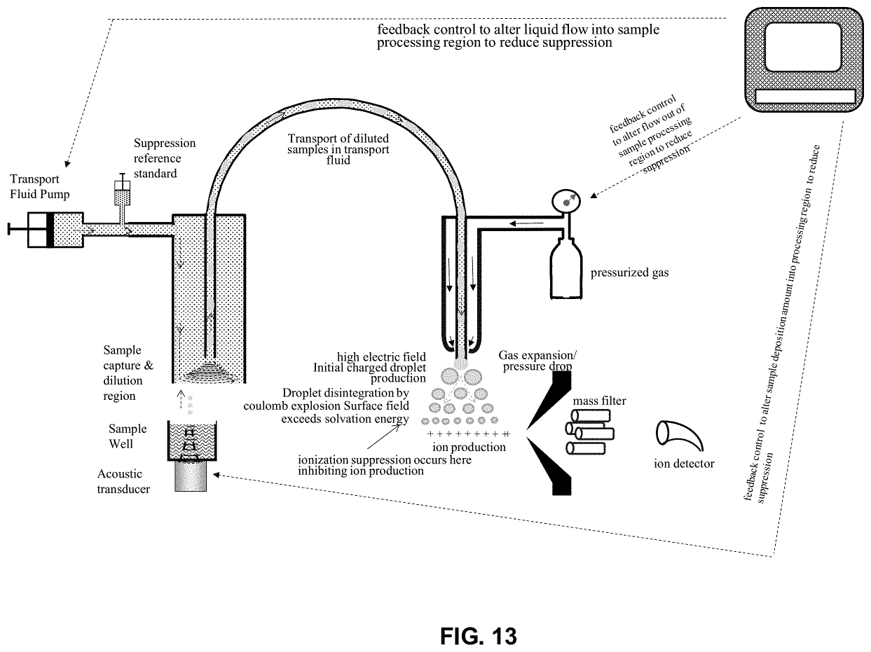

FIG. 13 is a simplified schematic illustrating an embodiment of a system for detecting ion suppression. The system of FIG. 13 includes an apparatus for introducing a suppression reference standard into the solvent transport flow of the capture probe. A controller is operative to detect the presence of the suppression reference standard in the analysis signal produced by the mass spectrometer. During operation, with introduction of analyte into the capture probe the controller is operative to detect ion suppression by evaluating the suppression reference standard signal. Suppression of the suppression reference standard signal from the initial value, i.e. signal deflection from the measured signal without analyte introduction, indicates that the introduced analyte is leading to ion suppression. The controller may then be operative to apply corrective action, for instance by decreasing the volume or frequency of analyte introduction into the capture probe, increase the solvent flow rate through the capture probe, etc.

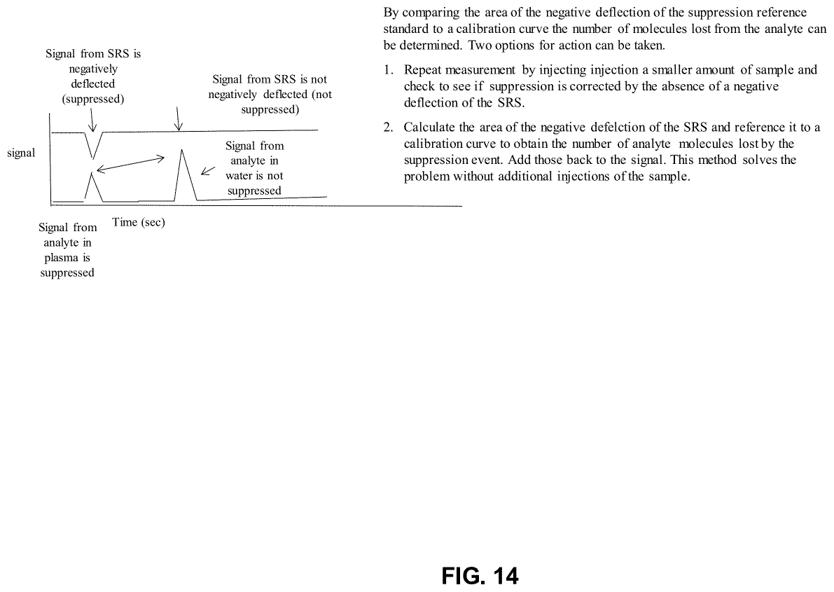

FIG. 14 is a diagram illustrating an embodiment of a method for correcting for ion suppression in an analytical result. The method of FIG. 14 may, for instance, be executed using a system similar to the system of FIG. 13. In the method, a magnitude of the deflection of the suppression reference standard signal may be evaluated to obtain a quantitative estimate of how much suppression is taking place. Corrective measures by a controller may then be taken based on the quantitative estimate.

In some aspects, the corrective measure may comprise, for instance, a controller adjusting one or more operational parameters of the system. For instance, the sample introduction volume or frequency, solvent flow rate, etc. In an aspect, the one or more operational parameters may be selected based on the quantitative estimate. In an aspect, the degree of correction applied to the one or more operational parameters may be determined based on the quantitative estimate. For instance, for a small deflection in the suppression reference standard signal a relatively small adjustment to sample introduction (droplet size or frequency), solvent flow rate, etc. may be made. In the case of a large deflection a corresponding larger adjustment may be made to correct for ion suppression. In this manner an ion suppression condition may be corrected with more efficiency and less trial and error than blind correction methods. In addition, the next measurement with the corrected operational parameters may be confirmed to have no, or little, ion suppression based on the suppression reference standard signal evaluated from the next measurement.

In some aspects, the corrective measure may comprise the controller making a calculated measurement adjustment to the measurement taken by the system. In this embodiment, rather than re-performing the measurement with adjusted operational parameters, the original measurement with detected ion suppression may be adjusted based on the quantitative estimate to produce an adjusted measurement result that corrects for the detected ion suppression.

As an example, a negative peak area from the suppression reference standard signal may be evaluated. The negative peak area may be compared to a calibration curve to determine a number of molecules “missing” from the measurement. This value may then be added back to the measurement signal including the analyte signal to correct for the ion suppression. In some aspects a peak threshold may be provided wherein correction is only applied in cases where the detected ion suppression is below the threshold. In cases where the detected ion suppression is above the peak threshold the measurement may be repeated with an adjustment to the operational parameters, as described above.

1. A device that produces charged droplets whose composition is optimized for the creation of ions by electrospray comprises of:
a sample delivery device that is operative to transfers sample components from a liquid sample to a processing chamber,
a flowing stream of liquid through the processing chamber into which the samples are deposited,
a controller operative to control the amount of sample transferred,
a transport tube through which the flowing liquid containing the sample is directed to an electrospray emitter with a high electric field at the exit,
a flow of expanding gas surrounding the electrospray emitter creating a pressure drop at the exit, and,
a mass spectrometer for measuring the number of ions produced from the charged droplets emanating from the emitter;
wherein the dilution of the sample in the processing chamber and transport fluid is from 100 to 10,000-fold.

2. The device according to claim 1 that varies the sample droplet volume directed into the processing chamber.

3. The device according to claim 1 that varies the frequency of sample droplet generation directed into the processing chamber.

4. The device according to claim 1 that varies the amount of sample introduced into the processing chamber from a solid surface by controlling the time the solid surface spends in a liquid sample.

5. The device according to claim 1 that varies the amount of sample introduced into the processing chamber from a solid surface by controlling the time the solid surface spends in the processing fluid.

6. The device according to claim 1 that varies the amount of sample introduced into the processing chamber from a solid surface by controlling the composition of the processing fluid in contact with the solid surface in the processing chamber.

7. The device according to claim 1 that varies the flow of the fluid in the processing chamber.

8. The device according to claim 1 that varies the flow of the nebulizer gas.

9. The device according to claim 1, further operative to determine a relationship between the amount of sample injected and signal produced in the mass spectrometer and compares it to a known normal relationship.

10. The device of claim 9 further operative to adjust the amount of sample introduced into the processing chamber to another value if the relationship between sample amount and signal varies from the normal.

11. The device of claim 9 further operative to adjust the sample droplet frequency to another value if the relationship between sample amount and signal varies from the normal.

12. The device of claim 9 further operative to adjust the transport flow to another value if the relationship between sample amount and signal varies from the normal.

13. The device of claim 9 further operative to adjust the nebulizer gas flow to another value if the relationship between sample amount and signal varies from the normal.

14. The device of claim 9 further operative to adjust the amount of time a solid sample is in contact with the fluid in the processing chamber to another value if the relationship between sample amount and signal varies from the normal.

15. The device of claim 9 further operative to adjust the composition of the solvent in the processing chamber in contact with a solid sample to another value if the relationship between sample amount and signal varies from the normal.

16. A method for adjusting a composition of the charged droplets that create gas phase ions to compensate for samples whose composition is outside the boundaries of those required for optimal ion production by:
creating sample droplets from a liquid sample,
introducing said sample droplets into a flowing stream of liquid,
diluting said sample droplets in said flowing stream of liquid from 100 to 10,000 fold, and
introducing the flowing stream of liquid and said diluted sample droplets into an electrospray ionization mass spectrometer to obtain a signal representative of components of the sample.

17. A method according to claim 16 which increases the amount of the sample introduced by increasing the sample droplet volume and determines the relationship between amount of sample introduced and the mass spectrometer signal and wherein the method optionally further comprises comparing the relationship between the amount of sample introduced and the mass spectrometer signal to a calibration curve of sample amount versus signal predetermined under solution composition conditions for ideal ion production from charged droplets.

18. A method according to claim 16 which increases the amount of the sample introduced by increasing the frequency of sample droplet introduction determines the relationship between amount of sample introduced and the mass spectrometer signal and wherein the method optionally further comprises comparing the relationship between the amount of sample introduced and the mass spectrometer signal to a calibration curve of sample amount versus signal predetermined under solution composition conditions for ideal ion production from charged droplets.

19. (canceled)

20. A method according to claim 16 which decreases the amount of sample introduced by lowering the droplet volume until the relationship between the amount of sample introduced and the mass spectrometer signal is equivalent to that of an ideal calibration curve of sample amount versus signal.

21. A method according to claim 16 which decreases the amount of sample introduced by lowering the frequency of sample droplet introduction until the relationship between the amount of sample introduced and the mass spectrometer signal is equivalent to that of an ideal calibration curve of sample amount versus signal.

22. (canceled)
